(19) United States
(12) Patent Application Publication
(10) Pub. No.: US 2009/0158701 A1
(43) Pub. Date: Jun. 25, 2009

(54) SYSTEMS AND METHODS FOR POWER GENERATION WITH CARBON DIOXIDE ISOLATION

(75) Inventors: Stephanie Marie-Noelle Hoffmann, Bavaria (DE); Michael Adam Bartlett, Bavaria (DE); Paul Steven Wallace, Katy, TX (US)

Correspondence Address: GENERAL ELECTRIC COMPANY;GLOBAL RESEARCH, PATENT DOCKET RM. BLDG. K1-4A59, NISKAYUNA, NY, 12309, US

(73) Assignee: GENERAL ELECTRIC COMPANY, SCHENECTADY, NY (US)

(21) Appl. No.: 11/960,865

(22) Filed: Dec. 20, 2007

(51) Int. Cl. F02B 43/00

(52) U.S. Cl. 60/39.12

(57) ABSTRACT

A power generation system includes at least one turbine system comprising a compressor section configured to supply a first portion and a second portion of compressed oxidant and an oxidant booster to further boost pressure of the first portion of compressed oxidant to generate a high pressure oxidant. The power generation system further includes a partial oxidation unit configured to receive the high pressure oxidant and a compressed fuel to generate a high pressure fuel stream and a CO₂ separation system fluidly coupled to the partial oxidation unit for receiving the high pressure fuel stream and provide a CO₂ lean fuel stream. A syngas expander is configured to receive the CO₂ lean fuel stream to utilize the energy content in the CO₂ lean fuel stream to generate a partially expanded fuel stream and a combustion chamber is configured to combust the second portion of compressed oxidant and the partially expanded fuel stream to generate a hot flue gas. An expander section is provided having an inlet for receiving the hot flue gas configured to generate electrical energy and an expanded exhaust gas lean in CO₂.

### BACKGROUND

The invention relates generally to power generation and efficient recovery of carbon dioxide. More particularly, the invention relates to the generation of synthesis gas at high pressure and separation of carbon dioxide prior to combustion in power generation systems.

Power generation systems that combust fuels containing carbon, for example, fossil fuels, produce carbon dioxide (CO₂) as a byproduct during combustion as carbon is converted to CO₂. Carbon dioxide (CO₂) emissions from power plants utilizing fossil fuels are increasingly penalized by national and international regulations, such as the Kyoto protocol, and the EU Emission Trading Scheme. With increasing cost of emitting CO₂, CO₂ emission reduction is important for economic power generation. Removal or recovery of the carbon dioxide (CO₂) from power generation systems, such as from the exhaust of a gas turbine, is generally not economical due to the low CO₂ content and low (ambient) pressure of the exhaust. Therefore, the exhaust containing the CO₂ is typically released to the atmosphere, and does not get sequestered into oceans, mines, oil wells, geological saline reservoirs, and so on.

Gas turbine plants operate on the Brayton cycle. They use a compressor to compress the inlet air upstream of a combustion chamber. Then the fuel is introduced and ignited to produce a high temperature, high-pressure gas that enters and expands through the turbine section. The turbine section powers both the generator and compressor. Combustion turbines are also able to burn a wide range of liquid and gaseous fuels from crude oil to natural gas.

There are three generally recognized ways currently employed for reducing CO₂ emissions from such power stations. The first method is to capture CO₂ on the output side, wherein the CO₂ produced during the combustion is removed from the exhaust gases by an absorption process, diaphragms, cryogenic processes or combinations thereof. A second method includes reducing the carbon content of the fuel. In this method, the fuel is first converted into H₂ and CO₂ prior to combustion. Thus, it becomes possible to capture the carbon content of the fuel before entry into the gas turbine. A third method includes an oxy-fuel process. In this method, pure oxygen is used as the oxidant as opposed to air, thereby resulting in a flue gas consisting of carbon dioxide and water.

The main disadvantage of the method to capture the CO₂ on the output side is that the CO₂ partial pressure is very low on account of the low CO₂ concentration in the flue gas (typically 3-4% by volume for natural gas applications) and therefore large and expensive devices are needed for removing the CO₂. Therefore there is a need for a technique that provides for economical recovery of CO₂ discharged from power generation systems (for example, gas turbines) that rely on carbon-containing fuels.

### BRIEF DESCRIPTION

In one aspect, a power generation system includes at least one turbine system comprising a compressor section configured to supply a first portion and a second portion of compressed oxidant and an oxidant booster to further boost pressure of the first portion of compressed oxidant to generate a high pressure oxidant. The power generation system further includes a partial oxidation unit configured to receive the high pressure oxidant and a compressed fuel to generate a high pressure fuel stream and a CO₂ separation system fluidly coupled to said partial oxidation unit for receiving said high pressure fuel stream and provide a CO₂ lean fuel stream. A syngas expander is configured to receive the CO₂ lean fuel stream to utilize the energy content in said CO₂ lean fuel stream to generate a partially expanded fuel stream and a combustion chamber is configured to combust the second portion of compressed oxidant and the partially expanded fuel stream to generate a hot flue gas. An expander section is provided having an inlet for receiving the hot flue gas configured to generate electrical energy and an expanded exhaust gas lean in CO₂.

In another aspect, a power generation system includes at least one turbine system comprising a compressor section configured to supply a first portion and a second portion of compressed oxidant and an oxidant booster to further boost pressure of the first portion of compressed oxidant to generate a high pressure oxidant. The power generation system further includes a partial oxidation unit configured to receive the high pressure oxidant and a compressed fuel to generate a high pressure fuel stream and a CO₂ separation system fluidly coupled to said partial oxidation unit for receiving said high pressure fuel stream and provide a CO₂ lean fuel stream. A syngas expander is configured to receive the CO₂ lean fuel stream to utilize the energy content in said CO₂ lean fuel stream to generate a partially expanded fuel stream and the compressed fuel and a combustion chamber is configured to combust the second portion of compressed oxidant and the partially expanded fuel stream to generate a hot flue gas. An expander section is provided having an inlet for receiving the hot flue gas configured to generate electrical energy and an expanded exhaust gas lean in CO₂. The carbon dioxide separation system comprises a separation unit utilizing differences in component boiling points to remove CO₂ from said high-pressure fuel stream.

In yet another aspect, a method for generating power includes generating a first portion and a second portion of compressed oxidant in a compressor section of a turbine system and increasing the pressure of the first portion of compressed oxidant and generating a high pressure oxidant in an oxidant booster. The method also includes generating a high-pressure fuel stream in a partial oxidation unit by reacting the high-pressure oxidant and a compressed fuel and separating CO₂ from the high-pressure fuel stream in a CO₂ separation system using a cryogenic separation system and generating a CO₂ lean fuel stream. The method further includes expanding the CO₂ lean fuel stream in a syn-gas expander by utilizing the energy content in the CO₂ lean fuel stream and generating a partially expanded fuel stream and the compressed fuel. The method further includes combusting said second portion of compressed oxidant and said partially expanded fuel stream to generate a hot flue gas and expanding the hot flue gas and generating electrical energy and an expanded exhaust gas lean in CO₂.

### DRAWINGS

These and other features, aspects, and advantages of the present invention will become better understood when the following detailed description is read with reference to the accompanying drawings in which like characters represent like parts throughout the drawings, wherein:

FIG. 1 is a schematic illustration of an exemplary power generation system with carbon dioxide separation system in accordance with certain embodiments of the present invention; and

FIG. 2 is a schematic illustration of another exemplary power generation system with carbon dioxide separation system in accordance with certain embodiments of the present invention.

### DETAILED DESCRIPTION

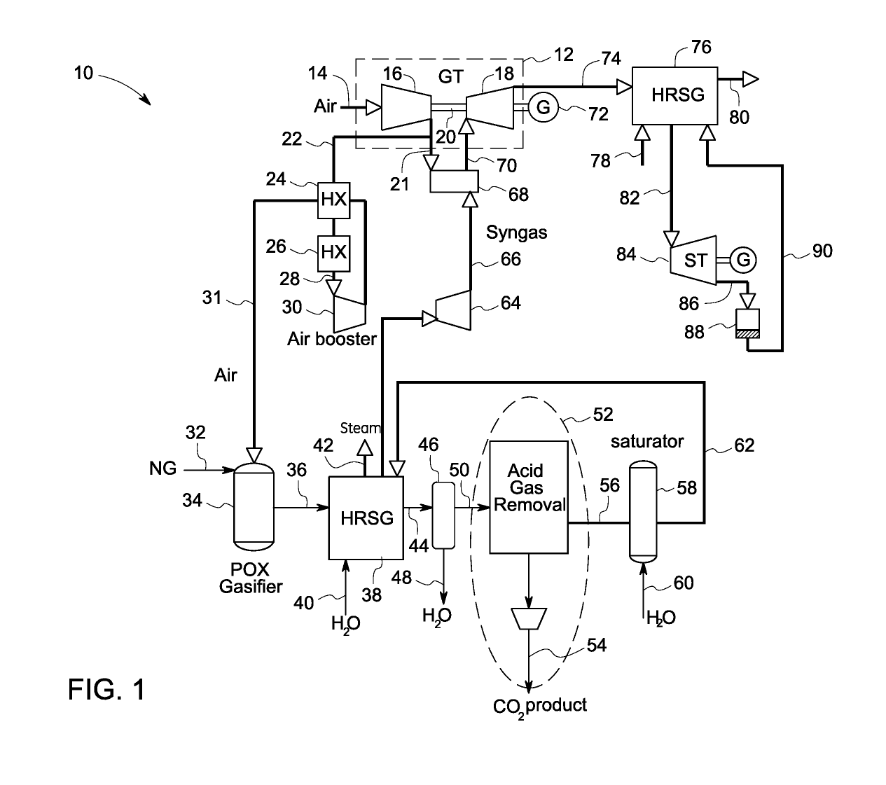

The present technique provides a power generation system 10 including at least one turbine system. As shown in FIG. 1, the turbine system 12 includes a compressor section 16 configured to receive an oxidant 14 typically at ambient conditions and supply a first portion 22 and a second portion 21 of compressed oxidant. An oxidant booster 30 is provided to further boost the pressure of the first portion of compressed oxidant 22 to generate a high-pressure oxidant 31. A partial oxidation unit 34 is configured to receive the high-pressure oxidant 31 and a compressed fuel 32 to generate a high-pressure fuel stream 36. The power generation system 10 also includes a CO₂ separation system 52 fluidly coupled to the partial oxidation unit 34 for receiving the high pressure fuel stream 36 and provide a CO₂ lean fuel stream 56. A syn-gas expander 64 is configured to receive the CO₂ lean fuel stream 56 to utilize the energy content in the CO₂ lean fuel stream 56 to generate a partially expanded fuel stream 66. A combustion chamber 68 is configured to combust the second portion of compressed oxidant 21 and the partially expanded fuel stream 66 to generate a hot flue gas 70. The turbine system 10 further includes an expander section 18 having an inlet for receiving the hot flue gas 70 and is configured to generate electrical energy and an expanded exhaust gas 74 lean in CO₂.

Referring now to FIG. 1, there is illustrated an exemplary power generation system 10 with a gas turbine system 12. The gas turbine system 12 generally includes a compressor section 16. In one embodiment, the compressor section 16 includes at least one stage. In some other embodiments, compressor section 16 includes at least two compression stages. As stated earlier, the compressor section 16 is configured to generate a first portion 22 and a second portion 21 of compressed oxidant. In operation, the first portion of compressed oxidant 22 is passed through one or more heat exchangers 24 and 26 to reduce the temperature of the first portion of compressed oxidant 22 entering the oxidant booster 30. The high-pressure oxidant 31 from the oxidant booster 30 and the compressed fuel 32 is fed into the partial oxidation unit 34 (POX). The partial oxidation unit 34 enables a reforming process at a high pressure to convert the compressed fuel 32 into a high-pressure fuel stream 36 in reaction with the high-pressure oxidant 31.

In one embodiment, the high-pressure fuel stream 36 comprises synthesis gas. One embodiment of the present technique provides generation of synthesis gas at a higher pressure in the partial oxidation unit 34. Synthesis gas typically includes hydrogen, carbon monoxide, carbon dioxide, nitrogen, water and un-reacted hydrocarbons such as methane. Generation of synthesis gas at high pressure facilitates removal of CO₂ from the synthesis gas in the downstream processes. In operation, the availability of high-pressure in the high-pressure fuel stream 36 makes the CO₂ separation process more energy efficient. The primary reactions that occur over the partial oxidation process are indicated in reactions 1-3 below:

CH₄+½O₂═CO+2H₂; (1)

CH₄+3/2O₂═CO+2H₂O. (2)

CH₄+2O₂═CO₂+2H₂O (3)

As shown in FIG. 1, the high-pressure fuel stream 36 is fed into a first heat recovery steam generator (HRSG) 38 to generate steam 42 from a feed water 40 and cool the high-pressure fuel stream 36. The cooled high-pressure fuel stream 44 passes through a condenser 46 to separate the water 48 present in the cooled high-pressure fuel stream 44. The resultant high-pressure fuel stream 50 is introduced into a CO₂ separation system 52.

In an exemplary system, the CO₂ separation system 52 is a distillation process (that is separation based on differences in component boiling points), operated at refrigerated temperatures. One exemplary example of this process is the Ryan Holmes process. This process separates CO₂ and generates a CO₂ rich stream 54 at about 30 bar pressure and a CO₂ lean high-pressure fuel stream 56. Typically in a Ryan Holmes process a series of distillation columns (not shown in FIG. 1) at cryogenic temperature are used to separate CO₂ from a gas stream comprising hydrocarbons. CO₂ is split from hydrocarbons in a first column and the overhead CO₂ product is recovered as a liquid product in a second column. The second column overhead containing both CO₂ and methane is directed to a demethanizer column to produce a CO₂ rich stream at a pressure of about 30 Bar. In some other embodiments, the CO₂ separation system 52 may include chemical/physical adsorption of CO₂. Alternatively a CO₂ rich stream 54 may also be generated through a membrane process that can utilize the availability of high pressure in the high-pressure fuel stream 36 to separate CO₂. In some other embodiments, physical and chemical absorption processes may be used to separate CO₂ from the high-pressure fuel stream 36.

The CO₂ lean high-pressure fuel stream 56 is fed into a saturator 58 wherein the CO₂ lean high pressure fuel stream 56 is saturated with introduction of hot water 60 which water 60 compensates for the loss of mass flow due to separation of CO₂ from the high pressure fuel stream 36. This saturation process keeps the volume of the flow into the turbine system 12 close to design conditions. The saturation process may be adiabatic or non-adiabatic in nature. In operation, the saturated CO₂ lean high-pressure fuel stream 62 is introduced in the syn-gas expander 64 to expand the saturated CO₂ lean high-pressure fuel stream 62 to generate a partially expanded fuel stream 66. In one embodiment, the energy generated by partially expanding the saturated CO₂ lean high-pressure fuel stream 62 is used to compress and generate the compressed fuel 32 (not shown in FIG. 1). The partially expanded fuel stream 66 is subsequently introduced into a combustion chamber 68 configured to combust the partially expanded fuel stream 66 and the second portion of compressed oxidant 21 to generate the hot flue gas 70. The hot flue gas 70 is sent to the expander section 18 configured to expand the hot flue gas 70 to generate the expanded exhaust gas lean in CO₂ 74 and electrical energy required for driving the compressor section 16, and a generator 72 through a common shaft 20.

In one embodiment, as shown in FIG. 1, the expanded exhaust gas 74 lean in CO₂ is introduced into a second HRSG 76 to utilize the heat content of the expanded exhaust gas 74. The second HRSG 76 is configured to generate steam 82 and a cooled exhaust 80 substantially free of CO₂. The steam 82 generated in the second HRSG 76 is expanded in a steam turbine 84 to generate electrical energy and expanded steam 86. The expanded steam 86 is treated in a water separator 88 and the separated water 90 is recycled back into the second HRSG 76 for further generation of steam.

In the illustrated embodiment as shown in FIG. 1, the compressor section 16 and the expander section 18 are coupled through a common shaft 20. In operation, this driving arrangement provides the energy required to drive the compressor from the energy generated in the expander.

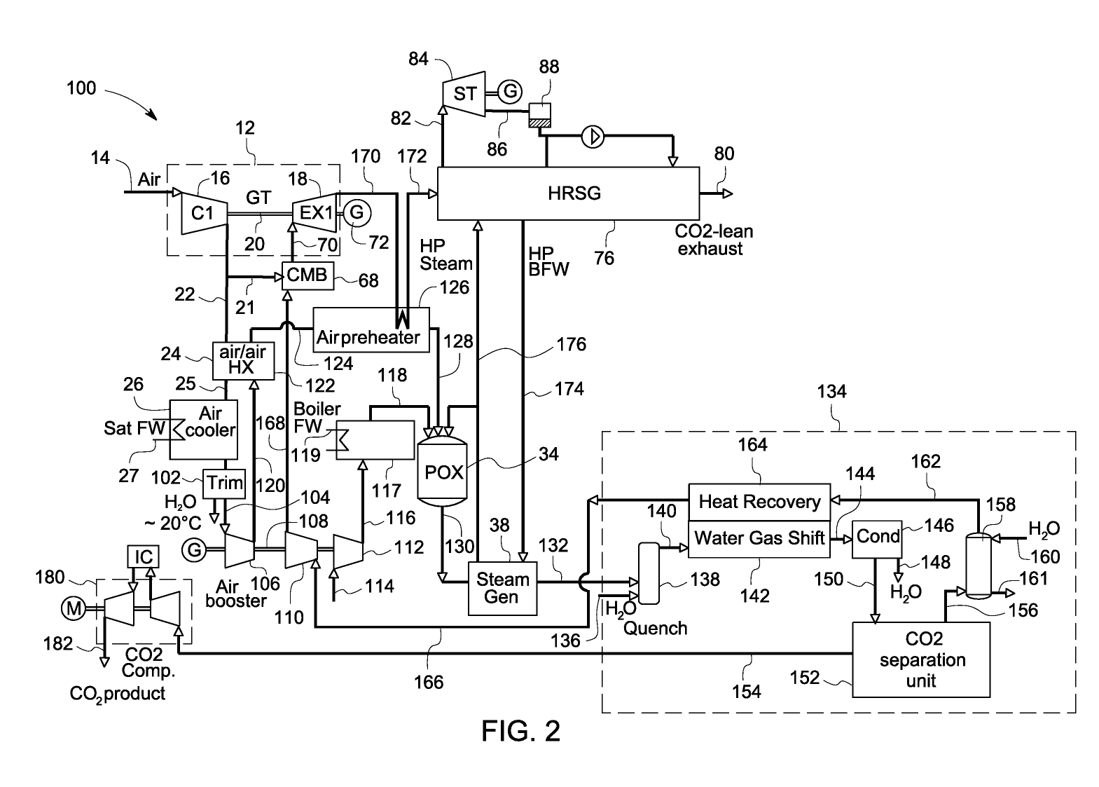

FIG. 2 illustrates an exemplary power generation system 100. Similar to the system shown in FIG. 1, the first portion of the compressed oxidant 22 from the compressor section 16 is sent to a heat exchanger 24 to cool down the first portion of the compressed oxidant 22. The cooled first portion of compressed oxidant 25 is further cooled in an oxidant cooler 26. The oxidant cooler 26 is configured to receive a stream of saturator feed water 27 and utilize the heat content of the first portion of compressed oxidant 22 to heat the water 27 and further cool the cooled first portion of compressed oxidant 25. The exit stream from the oxidant cooler 26 is sent to a trim 102 to further cool and knock out part of the water content from the exit stream and the cooled first portion of compressed oxidant 104 is introduced into the oxidant booster 106.

In an exemplary embodiment, the oxidant booster 106 as shown in FIG. 2, is coupled to the syn-gas expander 110. A fuel stream 114 is compressed to generate a compressed fuel 116 in a fuel compressor, which fuel compressor 116 is further coupled to the oxidant booster 106 through a common shaft 108. The compressed fuel 116 is preheated in a pre-heater 117 utilizing the heat content of any fluid stream such as boiler feed water 119. In one embodiment, the preheated compressed fuel 118 that is introduced to the POX reactor 34 is at a pressure of about 90 bar to about 110 bar. In one embodiment the compressed fuel 118 is at a pressure of about 100 bar.

The high-pressure oxidant 120 from the oxidant booster 106 is introduced into a heat exchanger 122 to exchange heat with the first portion of compressed oxidant 22. The heat exchanger 122 is configured to heat the high-pressure oxidant 120 utilizing the heat content of the first portion of compressed oxidant 22 and the heated high-pressure oxidant 124 is further heated in a pre-heater 126 before it is introduced into the POX reactor 34. The compressed and preheated fuel stream 118 is converted into the high-pressure fuel stream 130, which high-pressure fuel stream 130 comprises synthesis gas (syn gas). As stated in earlier sections a syn-gas includes hydrogen, carbon monoxide, carbon dioxide, nitrogen, water and un-reacted hydrocarbons such as methane. The high-pressure fuel stream 130 exiting the POX reactor is introduced into the first HRSG 38. The first HRSG 38 is configured to generate a cooled high-pressure fuel stream 132 and high-pressure steam 176 utilizing high-pressure boiler feed water 174. The cooled high-pressure fuel stream 132 is introduced into the CO₂ separation system 134 for CO₂ separation and isolation.

In an exemplary system as shown in FIG. 2, the CO₂ separation system 134 includes one or multiple water gas shift (WGS) reactor 142. This reactor may comprise of multiple stages and heat recovery units in between. The CO₂ separation system 134 may further include a quench 138, wherein the cooled high-pressure fuel stream 132 is further cooled by addition of water 136. The stream 140 exiting the quench 138 is introduced into the WGS reactor 142 for generation of hydrogen. In the following reaction called the water gas shift reaction (4), the carbon monoxide (CO) present in the cooled high-pressure fuel stream 132 reacts with water to generate CO₂ and hydrogen.

CO+H₂O [symbol] CO₂+H₂ (4)

Water gas shift reaction is an exothermic reaction and it enriches the exit stream 144 from WGS reactor 142 with hydrogen and CO₂. The hydrogen rich high-pressure fuel 144 from the WGS reactor 142 is further treated in a condenser 146 to separate the water 148 and the moisture free hydrogen rich high-pressure fuel 150 is introduced into a CO₂ separation unit 152. In an exemplary embodiment, the CO₂ separation unit 152, as described in the earlier sections includes the Ryan Holmes process that enhances generation of a CO₂ rich stream 154 at a substantially high pressure and a high pressure CO₂ lean fuel 156 in a cryogenic process.

The CO₂ rich stream 154 is further compressed in a compressor 180 including one or more stages to generate a high-pressure CO₂ rich stream 182. The generation of CO₂ rich stream at a high pressure of about 30 bar makes the entire CO₂ separation process energy efficient as less energy is required to further compress the CO₂ rich stream 154 before it is used in any other process or sold in the merchant market.

The CO₂ lean high-pressure fuel 156 is sent to the saturator 158, where the CO₂ lean high-pressure fuel 156 is saturated with water 160. The saturated CO₂ lean high-pressure fuel 162 is sent to a heat recovery unit 164. The cold water 161 exiting the saturator 160 is used internally to recover low-temperature heat from the plant, for example unit 26, 146, 164 and 180. In one exemplary embodiment, as shown in FIG. 2, the heat recovery unit 164 is coupled with the WGS reactor 142 which heat recovery unit 164 utilizes the heat generated by the exothermic water gas shift reaction to heat the CO₂ lean saturated high-pressure fuel 162 before it is introduced to the syn-gas expander 110. The syn-gas expander 110 expands the CO₂ lean high-pressure saturated fuel stream 166 exiting the heat recovery unit 164 to generate a partially expanded fuel stream 168 and energy to operate the oxidant booster 106 and the fuel compressor 112.

As discussed in the earlier sections, the partially expanded fuel stream 168 is sent to the combustion chamber 68 along with the second portion of compressed oxidant 21 to generate a hot flue gas 70. The hot flue gas 70 is expanded in an expander section 18 to generate an expanded exhaust stream 170 and electrical energy. The heat from the expanded exhaust 170 is recovered first by passing the expanded exhaust 170 through the high-pressure oxidant pre-heater 126 to heat the high-pressure oxidant stream 124. Subsequently the partially cooled expanded exhaust 172 is introduced to a bottoming steam cycle as described in the earlier sections to generate steam 82 in a second HRSG 76 and a substantially CO₂ free exhaust stream 80.

In the various embodiments of the power generation systems described herein, the oxidant 14 is ambient air. It is understood that the compressed oxidant from the compressor section may comprise any other suitable gas containing oxygen, such as for example, oxygen rich air, oxygen depleted air, and/or pure oxygen.

The fuel stream 114 may include any suitable hydrocarbon gas or liquid, such as natural gas, methane, naphtha, butane, propane, diesel, kerosene, aviation fuel, coal derived fuel, bio-fuel, oxygenated hydrocarbon feedstock, and mixtures thereof, and so forth. In one embodiment, the fuel is primarily natural gas (NG) and, therefore, the high-pressure fuel stream may include water, carbon dioxide (CO₂), carbon monoxide (CO), nitrogen (N₂) if the oxidant is air, unburned fuel, and other compounds.

In the exemplary embodiments as depicted in FIGS. 1-2, substantial carbon dioxide isolation is achieved. The expanded exhaust generated from the expander section is substantially free from carbon dioxide and the cooled expanded exhaust stream vented to atmosphere typically does not release any substantial amount of carbon dioxide. The CO₂ content in the high-pressure fuel stream is separated in the CO₂ separation system and may be sequestrated or sold in the merchant market depending on the demand for carbon dioxide.

Typically the power generation cycles that integrate CO₂ separation and isolation show a substantial decrease (in the range of about 12% points) in the overall cycle efficiency compared to a power cycle without CO₂ separation. But the power generation systems described above show a smaller decrease in the over all cycle efficiency due to the following reasons. Using the Ryan Holmes process that produces high purity CO2 rich streams at a pressure of about 30 bar reduces the energy required for CO2 compression work. Additionally the humidification process in the saturator compensates for the flow deficit through the turbines due to the CO₂ removal, thereby increasing the power output. Furthermore, it ensures a better flow matching between the compressor and expander sections of the gas turbine. The power generation system and method described above also has several cost advantages. The fuel reforming process is carried out in the high pressure POX reactor at elevated pressures, (i.e. above the working pressure of the gas turbine). This reduces the size of the equipments used in the generation of the high-pressure fuel stream and also the size of the CO₂ separation system. In the present techniques, a POX reactor is used instead of a conventional auto-thermal reforming reactor for reforming the inkling fuel. This eliminates the need for fuel desulfurisation and use of high temperature catalysts. The CO₂ separation unit produces CO₂ at elevated pressures (at about 30 bar). This reduces compression costs for CO₂ transportation to end-use. On the oxidant side, due to the use of the oxidant booster, the oxidant is available at high pressure thereby reducing the equipment size, and hence cost of the POX reactor, the water gas shift reactor, the saturator and the condenser.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A power generation system comprising:
at least one turbine system comprising a compressor section configured to supply a first portion and a second portion of compressed oxidant;
an oxidant booster to further boost pressure of said first portion of compressed oxidant to generate a high pressure oxidant;
a partial oxidation unit configured to receive said high pressure oxidant and a compressed fuel to generate a high pressure fuel stream;
a CO₂ separation system fluidly coupled to said partial oxidation unit for receiving said high pressure fuel stream and provide a CO₂ lean fuel stream;
a syngas expander configured to receive said CO₂ lean fuel stream to utilize the energy content in said CO₂ lean fuel stream to generate a partially expanded fuel stream;
a combustion chamber configured to combust said second portion of compressed oxidant and said partially expanded fuel stream to generate a hot flue gas; and
an expander section having an inlet for receiving said hot flue gas configured to generate electrical energy and an expanded exhaust gas lean in CO₂.

2. The system of claim 1, wherein said CO₂ separation system comprises one or multiple water gas shift reactors configured to receive said high pressure fuel stream and generate a hydrogen- and CO₂-rich high pressure fuel stream, wherein CO₂ is separated in said CO₂ separation system, and one or multiple heat exchangers configured to recover heat from said high pressure fuel stream.

3. The system of claim 1, wherein said CO₂ separation system further comprises a steam generator and a CO₂ separator.

4. The system of claim 3, wherein the carbon dioxide separator comprises a separation unit utilising differences in component boiling points to remove CO₂ from said high pressure fuel stream.

5. The system of claim 3, wherein the carbon dioxide separator comprises a separation unit using the principle of physical or chemical absorption to remove CO₂ from said high pressure fuel stream.

6. The system of claim 3, wherein the carbon dioxide separator comprises a membrane separation unit to remove CO₂ from said high pressure fuel stream.

7. The system of claim 2, wherein said CO₂ separation system further comprises an adiabatic quench unit configured to generate a saturated high pressure fuel stream at temperatures between about 50 to about 200° C. and to remove particles prior to said water gas shift reactor.

8. The system of claim 2, wherein said CO₂ separation system further comprises a condenser unit configured to remove heat and water from said high pressure fuel stream prior to said CO₂ separation system.

9. The system of claim 2, wherein said CO₂ separation system further comprises a saturator configured to provide a water-saturated CO₂-lean fuel stream at temperatures from about 100 to about 250° C.

10. The system of claim 9, wherein said saturator utilises hot water generated from recovering heat from one or more of said first portion of compressed oxidant, high pressure fuel stream and CO₂ lean fuel stream.

11. The system of claim 10, wherein said saturator utilises a non-adiabatic process, generating a cool water exit that is circulated along with make-up water to recover heat from one or more of said first portion of compressed oxidant, high pressure fuel stream and CO₂ lean fuel stream.

12. The system of claim 1, further comprising a heat recovery steam generator configured to recover heat from said exhaust gas and generate high pressure steam and a cooled exhaust stream.

13. The system of claim 5 further comprising a steam turbine configured to use said high pressure steam to generate electrical energy.

14. The system of claim 1, wherein said energy content in said CO₂ lean fuel stream is utilized to generate said high pressure oxidant.

15. The system of claim 14, wherein said energy content in said CO₂ lean fuel stream is extracted with a turbine operating on the same shaft as the compressors utilized to generate said high pressure oxidant.

16. The system of claim 1, wherein said energy content in said CO₂ lean fuel stream is utilized to generate said compressed fuel.

17. The system of claim 1, wherein said cooled exhaust stream is substantially free of CO₂.

18. The system of claim 1, wherein said compressed fuel comprises natural gas.

19. The system of claim 1, wherein said compressed fuel comprises a hydrocarbon-containing liquid or gas.

20. The system of claim 1, wherein said oxidant is air.

21. A power generation system comprising:
at least one turbine system comprising a compressor section configured to supply a first portion and a second portion of compressed oxidant;
an oxidant booster to further boost pressure of said first portion of compressed oxidant to generate a high pressure oxidant;
a partial oxidation unit configured to receive said high pressure oxidant and a compressed fuel to generate a high pressure fuel stream;
a CO₂ separation system fluidly coupled to said partial oxidation unit for receiving said high pressure fuel stream and provide a CO₂ lean fuel stream;
a syngas expander configured to receive said CO₂ lean fuel stream to utilize the energy content in said CO₂ lean fuel stream to generate a partially expanded fuel stream and said compressed fuel;
a combustion chamber configured to combust said second portion of compressed oxidant and said partially expanded fuel stream to generate a hot flue gas; and
an expander section having an inlet for receiving said hot flue gas configured to generate electrical energy and an expanded exhaust gas lean in CO₂;
wherein said carbon dioxide separation system comprises a separation unit utilising differences in component boiling points to remove CO₂ from said high pressure fuel stream.

22. A method for generating power comprising:
generating a first portion and a second portion of compressed oxidant in a compressor section of a turbine system;
increasing the pressure of said first portion of compressed oxidant and generating a high pressure oxidant in an oxidant booster;
generating a high pressure fuel stream in a partial oxidation unit by reacting said high pressure oxidant and a compressed fuel;
separating CO₂ from said high pressure fuel stream in a CO₂ separation system using a cryogenic separation system and generating a CO₂ lean fuel stream;
expanding said CO₂ lean fuel stream in a syn-gas expander by utilizing the energy content in said CO₂ lean fuel stream and generating a partially expanded fuel stream and said compressed fuel;
combusting said second portion of compressed oxidant and said partially expanded fuel stream to generate a hot flue gas; and
expanding said hot flue gas and generating electrical energy and a expanded exhaust gas lean in CO₂.

23. The method of claim 22, wherein said compressed fuel comprises natural gas.

24. The method of claim 22, wherein said oxidant is air.

25. The method of claim 22 further comprises generating a hydrogen rich high pressure fuel stream in a water gas shift reactor configured to receive said high pressure fuel stream and recovering heat in a heat exchanger from said high pressure fuel stream.

26. The method of claim 22 further comprising recovering heat from said expanded exhaust gas and generating steam in a heat recovery steam generator.
